(19) United States
(12) Patent Application Publication
(10) Pub. No.: US 2021/0204560 A1
(43) Pub. Date: Jul. 8, 2021

(54) Atomized Powder of Coca Leaf without Alkaloid for the Food Industry

(71) Applicants: YANIV BEN-MOSHE, NEW YORK, NY (US); NICHOLAS MATTHEW NOVOA, NEW YORK, NY (US)

(72) Inventors: YANIV BEN-MOSHE, NEW YORK, NY (US); NICHOLAS MATTHEW NOVOA, NEW YORK, NY (US)

(21) Appl. No.: 17/023,528

(22) Filed: Sep. 17, 2020

Related U.S. Application Data
(60) Provisional application No. 62/905,484, filed on Sep. 25, 2019.

(51) Int. Cl. A23F 3/36; A23L 2/52; A23F 3/14; A23F 3/30; A23L 5/20; C12G 3/00; A23L 33/105

(52) U.S. Cl. CPC A23F 3/36; A23L 2/52; A23F 3/14; A23V 2002/00; A23L 5/20; C12G 3/00; A23L 33/105; A23F 3/30

(57) ABSTRACT

In order to provide people with healthier options for beverages, coca leaf without alkaloid is provided. The extract from the coca leaf without alkaloid can be used for natural coca tea-based beverages, which include liquor.

### FIELD OF THE INVENTION

One aspect of the invention relates to atomized powder of coca leaf without alkaloid for the food industry.

Another aspect of the invention relates to the extract of coca with its components: essential oils, fatty acids, triterpenoids, flavonoids, carotenoids, polios, starch, vitamin C and vitamin B complex, amino acids, tannins, saponins, resins.

### BACKGROUND OF THE INVENTION

The Coca leaf has been used by the indigenous people of Peru and the greater Andean region for centuries for its beneficial properties. In the times of the Incas, it was considered a divine gift. Cultivation of coca was performed with reverence and care; priests used the leaves in virtually all ceremonies and rituals.

Today, the people who live in the highlands continue using it on a daily basis. When tourists arrive in Cusco, they are given hot coca tea to help alleviate the effects of high-altitude sickness.

The coca leaf is basically a benign herbal material which provides vitamins and minerals, and also helps to regulate blood glucose, enhance metabolism and help to reduce the tendency toward adult onset diabetes and obesity. It is also used to increase energy and improve physical performance.

It is known for its anti-inflammatory properties often taken to alleviate arthritis and similar ailments. Coca leaf is also rich in beneficial antioxidants, including ones that help to protect the integrity of blood vessels. In addition, coca extracts are used for stimulating stomach function, and treating asthma, colds, and other ailments.

Studies have established that traditional coca consumption increases tolerance for physical labor; helps the lungs to absorb more oxygen; helps to prevent the aggregation of platelets in the blood, resulting in a lower risk of thrombosis; and helps regulate the level of insulin in the body. (The Coca Museum, Hurtado and Silva in Bolivia). The coca leaf is a rich source of vitamins A and C, as well as calcium, iron, fiber, protein and calories. Coca is no more addictive than coffee and there is no proof that the consumption of the coca leaf is detrimental to one's health. The Coca is NOT Cocaine.

### SUMMARY OF THE INVENTION

The process allows consumption of the coca powder and coca liquid extract in several different presentations providing all the health benefits without the harmful alkaloid which is naturally present in the plant.

The process will make but is not limited to coca powder and coca liquid extract without the alkaloid.

### BRIEF DESCRIPTION OF THE DRAWINGS

FIGS. 1A and 1B show tea bags including the coca powder.

FIG. 2 shows a sachet including the coca powder.

FIGS. 3A and 3B show a container for the tea bags of FIGS. 1A and 1B.

FIGS. 4A and 4B show packaging of the coca powder that can be added to a beverage.

FIG. 5 shows the coca powder.

FIG. 6 shows a bottle containing unsweetened coca tea free of alkaloid.

FIG. 7 shows a bottle containing an energy drink which includes real coca leaf extract free of alkaloid.

FIG. 8 shows a bottle containing coca liquor with 100% natural coca leaf.

### DETAILED DESCRIPTION

One aspect of the invention relates to atomized powder of coca leaf without alkaloid for the food industry. Another aspect of the invention relates to the extract of coca with its components: essential oils, fatty acids, triterpenoids, flavonoids, carotenoids, polios, starch, vitamin C and vitamin B complex, amino acids, tannins, saponins, resins.

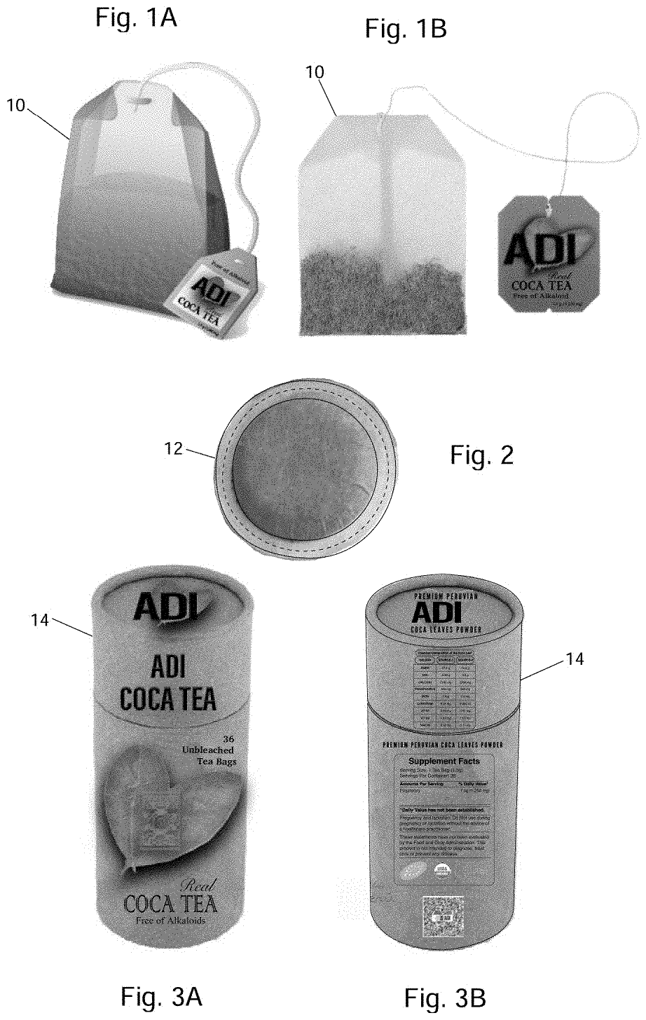

As shown in FIGS. 1A and 1B, the coca powder will be processed and packaged in but not limited to tea bags 10.

As shown in FIG. 2, the coca powder will be processed and packaged in but not limited to sachets 12.

FIGS. 3A and 3B show an exemplary container 14 for the tea bags 10 of FIGS. 1A and 1B.

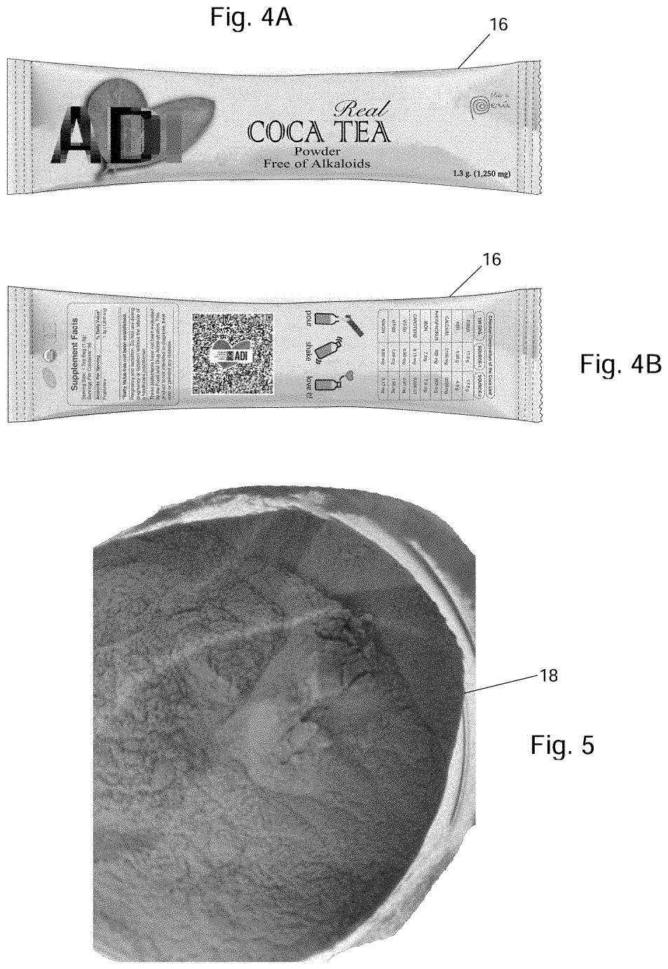

FIGS. 4A and 4B show a package 16 containing coca tea powder free of alkaloids that can be added to any drink or food.

FIG. 5 shows the coca tea powder 18 free of alkaloids.

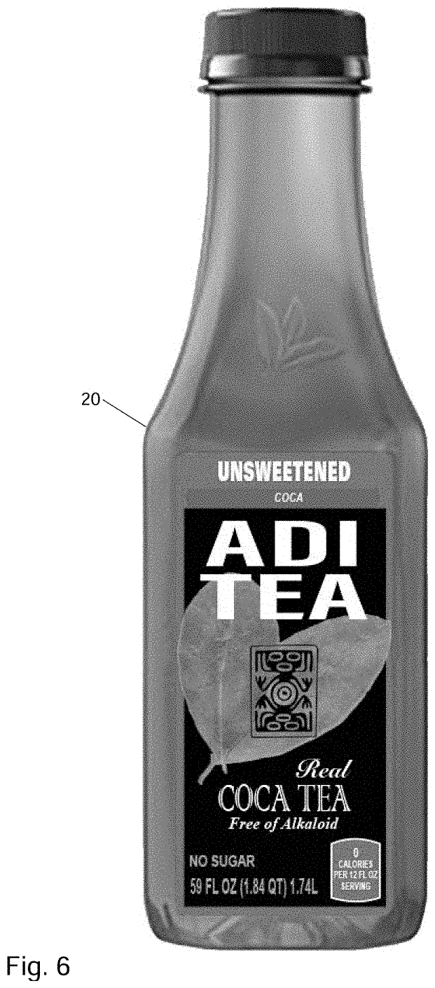

As shown in FIG. 6, the coca extract will be used but not limited to making ready to drink iced tea in bottles 20.

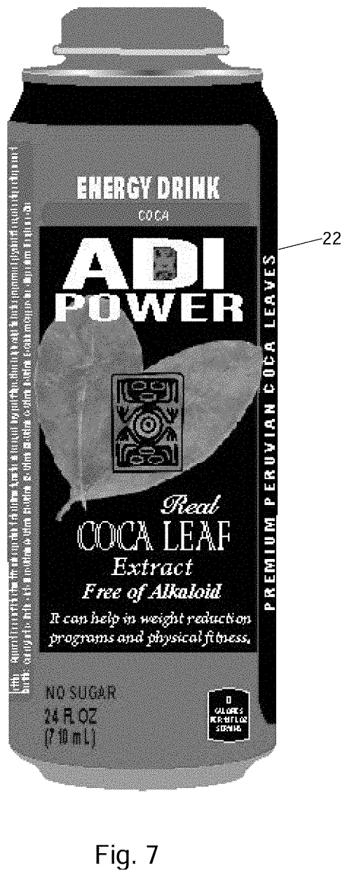

As shown in FIG. 7, the coca extract will be used but not limited to making energy drinks 22.

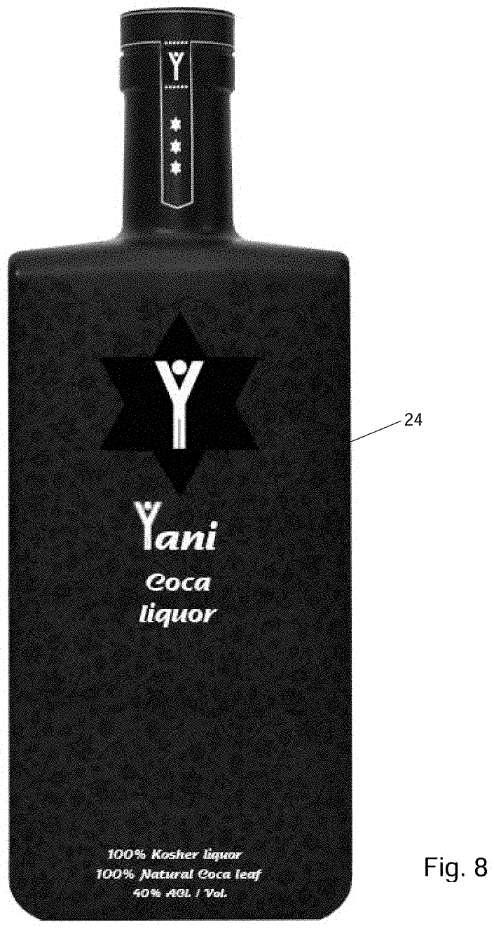

As shown in FIG. 8, the coca extract will be used to but not limited to making distilled spirits 24.

The coca leaf is basically a benign herbal material which provides vitamins and minerals, and also helps to regulate blood glucose, enhance metabolism and help to reduce the tendency toward adult onset diabetes and obesity. It is also used to increase energy and improve physical performance.

It is known for its anti-inflammatory properties often taken to alleviate arthritis and similar ailments. Coca leaf is also rich in beneficial antioxidants, including ones that help to protect the integrity of blood vessels. In addition, coca extracts are used for stimulating stomach function, and treating asthma, colds, and other ailments.

Studies have established that traditional coca consumption increases tolerance for physical labor; helps the lungs to absorb more oxygen; helps to prevent the aggregation of platelets in the blood, resulting in a lower risk of thrombosis; and helps regulate the level of insulin in the body. (The Coca Museum, Hurtado and Silva in Bolivia). The coca leaf is a rich source of vitamins A and C, as well as calcium, iron, fiber, protein and calories. Coca is no more addictive than coffee and there is no proof that the consumption of the coca leaf is detrimental to one's health. The Coca is NOT Cocaine.

1. (canceled)

2. A beverage comprising an atomized powder of coca leaf, wherein the atomized powder of coca leaf is free of alkaloid.

3. The beverage of claim 1, wherein the beverage is an energy drink.

4. The beverage of claim 1, wherein the beverage is tea.

5. The beverage of claim 4, wherein the beverage is ice tea.

6. The beverage of claim 1, wherein the beverage is a liquor.

7. The beverage of claim 1, wherein the atomized powder of coca leaf is provided in a packet separate from the beverage.

8. The beverage of claim 1, wherein the packet is a tea bag or sachet.
